(19) United States
(12) Patent Application Publication
(10) Pub. No.: US 2021/0344299 A1
(43) Pub. Date: Nov. 4, 2021

(54) SOLAR POWERED ROBOTIC MOWER POWER SHED AND RELATED METHODS OF USE

(71) Applicants: University of Tennessee Research Foundation, Knoxville, TN (US); Solar Alliance, Knoxville, TN (US)

(72) Inventors: Matthew Edward Layne, Knoxville, TN (US); Harvey Abouelata, Knoxville, TN (US); Jonathan B. Hamilton, Maryville, TN (US)

(73) Assignees: University of Tennessee Research Foundation, Knoxville, TN (US); Solar Alliance, Knoxville, TN (US)

(21) Appl. No.: 17/246,173

(22) Filed: Apr. 30, 2021

Related U.S. Application Data
(60) Provisional application No. 63/018,246, filed on Apr. 30, 2020.

(51) Int. Cl. H02S 20/30; G05B 15/02; H02J 7/35; H02J 7/00

(52) U.S. Cl. CPC H02S 20/30; G05B 15/02; H04W 84/12; H02J 7/0047; H02J 7/35

(57) ABSTRACT

A solar powered robotic mower power shed and related methods of use are disclosed. One example robotic mower power shed comprises a housing structure containing one or more compartments. The charging station further includes a roof structure equipped with one or more photovoltaic (PV) cell elements, wherein the one or more PV cell elements are configured to generate electrical energy from captured solar energy. The charging station also includes a charge control unit configured to receive electrical energy via a connection to the one or more PV cell elements and to provide the electrical energy to at least a robotic mower device docked in the housing structure.

### PRIORITY CLAIM

This application claims benefit of U.S. Provisional Patent Application Ser. No. 63/018,246 filed Apr. 30, 2020, the disclosure of which is incorporated herein by reference in its entirety.

### TECHNICAL FIELD

The subject matter described herein relates to robotic mowers and associated solar powered garages, sheds, and other stations. More particularly, the subject matter described herein relates to a solar powered robotic mower power shed and related methods of use.

### BACKGROUND

Robotics, communications, and autonomy-related technologies are advancing at a tremendous rate. These technologies are increasingly finding their way into mainstream consumer product lines. From sensor communication to propulsion systems, these consumer robotic devices are primarily powered by electricity. Specifically, for robotic and autonomous lawn mowers, this notion requires a tether to grid power for charging as well as energy storage for operations. This factor notably impacts equipment siting, safety, convenience, and expense. Consequently, there is a need to provide power to these devices with options that enhance the safety, cost, convenience, and functionality of robotic lawnmower devices.

Thus, there currently exists a need in the industry for a solar powered robotic mower power shed and related methods of use.

### SUMMARY

The subject matter described herein includes a solar powered robotic mower power shed and related methods of use. One example robotic mower power shed comprises a housing structure containing one or more compartments. The charging station further includes a photovoltaic (PV) roof structure equipped with one or more photovoltaic (PV) cell elements, wherein the one or more PV cell elements are configured to generate electrical energy from captured solar energy. The charging station also includes a charge control unit configured to receive electrical energy via a connection to the one or more PV cell elements and to provide the electrical energy to at least a robotic mower docked in the housing structure.

In some embodiments, the robotic mower power shed further comprises a battery unit configured to receive and store additional electrical energy from the charge control unit.

In some embodiments, the battery unit in the robotic mower power shed comprises a battery element of any size.

In some embodiments, the robotic mower power shed comprises a plurality of lighting elements. One example of the lighting elements include a low voltage lighting option such as LED(s).

In some embodiments, the plurality of light elements included in the robotic mower power shed is configured to provide visual status signals.

In some embodiments, each of the plurality of light elements of the robotic mower power shed is configured to emit a different color.

In some embodiments, wherein the one or more compartments in the housing structure comprise two or more compartments, and the two or more compartments are adjacently positioned either side-by-side or in a stacked arrangement.

In some embodiments, the one or more PV cell elements in the robotic mower power shed form a PV cell panel of any size.

In some embodiments, the housing structure of the robotic mower power shed is equipped with a Wi-Fi repeater module.

In some embodiments, the housing structure of the robotic mower power shed is equipped with a cellular communication module.

In some embodiments, the robotic mower power shed comprises a power outlet configured to charge additional power tool accessories and/or batteries via AC outlets and USB outlets.

In some embodiments, the housing structure of the robotic mower power shed is manufactured from at least one of a metallic material, a plastic material, and/or a composite material.

In some embodiments, the robotic mower power shed includes at least one carrying handle configured for transporting the robotic mower power shed.

In some embodiments, the robotic mower power shed is configured to be folded and/or disassembled in a compact form for shipment or transport.

In some embodiments, the housing structure of the robotic mower power shed includes at least one mower compartment door.

In some embodiments, the at least one mower compartment door of the robotic mower power shed is configured to be opened either manually or automatically.

In some embodiments, the housing structure of the robotic mower power shed is configured to include a plurality of entry points such that the robotic mower is able to enter and/or exit from multiple sides of the housing structure.

In some embodiments, the roof structure of the robotic mower power shed is configured to be adjusted to an angle that permits the one or more PV cell elements to optimally receive solar light.

In some embodiments, the roof structure of the robotic mower power shed is configured to be rotated.

In some embodiments, a smart phone application provisioned on a mobile device is configured to operate at least one of the roof structure, charge control unit, and the robotic mower device.

It is an object of the presently disclosed subject matter to provide a solar powered robotic mower power shed and related methods of use. An object of the presently disclosed subject matter having been stated hereinabove, and which is achieved in whole or in part by the presently disclosed subject matter, other objects will become evident as the description proceeds hereinbelow.

### BRIEF DESCRIPTION OF THE DRAWINGS

Preferred embodiments of the subject matter described herein will now be explained with reference to the accompanying drawings, wherein like reference numerals represent like parts, of which:

FIG. 1 is a diagram illustrating the rear view of an exemplary solar powered robotic mower power shed according to an embodiment of the subject matter described herein;

FIG. 2 is a block diagram illustrating the interior of an exemplary solar powered robotic mower power shed according to an embodiment of the subject matter described herein;

FIG. 3 is a diagram illustrating the front view of an exemplary solar powered robotic mower power shed according to an embodiment of the subject matter described herein;

FIGS. 4A and 4B depict a side view and a rear view of the slats used in an exemplary solar powered robotic mower power shed according to an embodiment of the subject matter described;

FIGS. 5A and 5B depict an interior side view and an interior rear view of the frame of an exemplary solar powered robotic mower power shed according to an embodiment of the subject matter described herein; and

FIG. 6 depicts a diagram of a front perspective view of an exemplary solar powered robotic mower power shed according to an embodiment of the subject matter described herein;

FIG. 7 depicts a diagram illustrating the interlocking features of an exemplary solar powered robotic mower power shed according to an embodiment of the subject matter described herein; and

FIG. 8 is a schematic diagram illustrating an exemplary electrical circuit corresponding to a solar powered robotic mower power shed according to an embodiment of the subject matter described herein.

### DETAILED DESCRIPTION

In accordance with some embodiments, the presently disclosed subject matter provides a solar powered robotic mower power shed. The solar powered robotic mower power shed described herein has characteristics and functions that enhance the benefits of autonomous robotic lawn mowers and their use. In some embodiments, the construction is a self-contained, self-sufficient power producing station with the component parts being elements of the structure, e.g., such as a solar panel construct that is also the roof, lid, and power producing unit. As such, a user or operator of the disclosed subject matter can site a power shed where a robotic mower can safely operate. Further, the power shed can be strategically positioned so that the solar rooftop can convert sunlight into electricity (e.g., positioned in such a manner that the solar rooftop is south facing in full sun). In addition, the power shed can be rotated to optimize time of day for maximum power desired. The power shed can also be deployed at or near an infrequent and/or low use area to be mowed based on the operation of the robotic mower. The charging station of the power shed is self-sufficient and does not require the use of surface laid electrical wiring or underground electrical wiring to obtain operational power since the solar rooftop of the power shed can produce (and store) the requisite electrical power needed for the operation of the robotic mower. The self-sufficient, self-contained power generation and storage station expands the useful market for robotic lawnmowers to remote areas that do not have existing power sources. Notably, the disclosed subject matter provides an untethered charging station that enables the deployment of a robotic mower in remote areas, expansive areas, and/or heavily trafficked areas. Examples of application locations for the power shed include, but are not limited to, athletic fields, a school and/or university campus, a corporate campus, a public park, a golf course, highway medians, and the like.

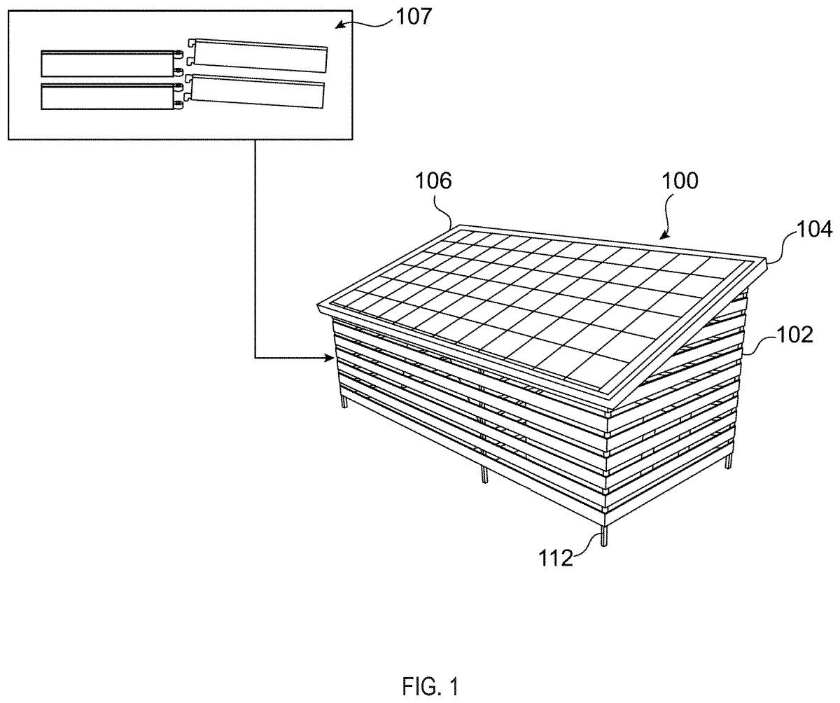

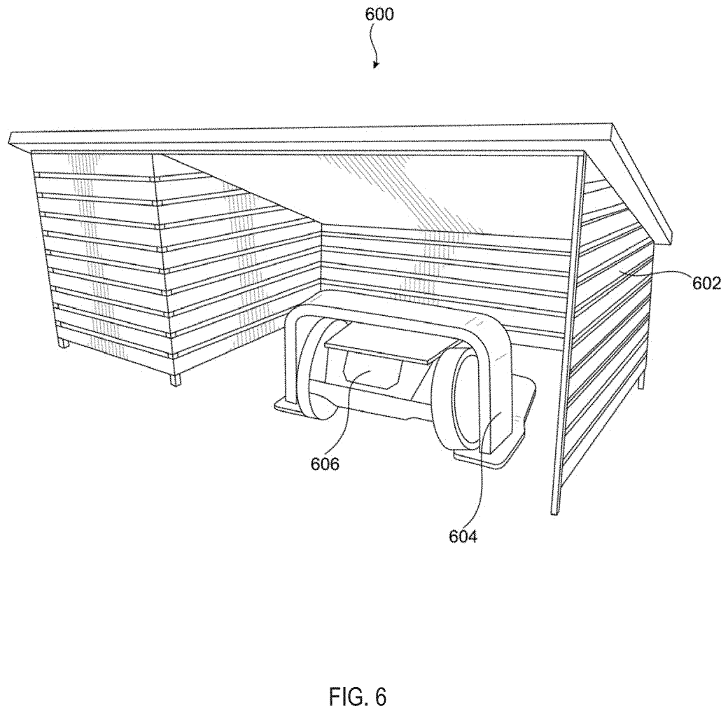

FIG. 1 is a diagram illustrating the rear view of an exemplary solar powered robotic mower power shed according to an embodiment of the subject matter described herein. In some embodiments, a solar powered robotic mower power shed 100 comprises a stand-alone housing structure 102 or other construct (e.g., a shed) that is equipped with a photovoltaic (PV) roof structure 104. For example, roof structure 104 provides cover over the interior of housing structure 102. In some embodiments, at least a portion of roof structure 104 (e.g., a section or the entirety of the roof structure) is equipped with one or more photovoltaic (PV) cell elements 106. Notably, the one or more PV cell elements 106 (e.g., a ‘solar PV module’) is configured to generate electrical energy that can be used by the robotic mower and/or the power shed for both operation and auxiliary functions. FIG. 1 further includes an inset illustration the depicts an interlocking system 107 that allows the power shed 100 to be easily assembled and/or disassembled and shipped flat. Additional details pertaining to the interlocking system 107 is described below and shown in FIG. 6.

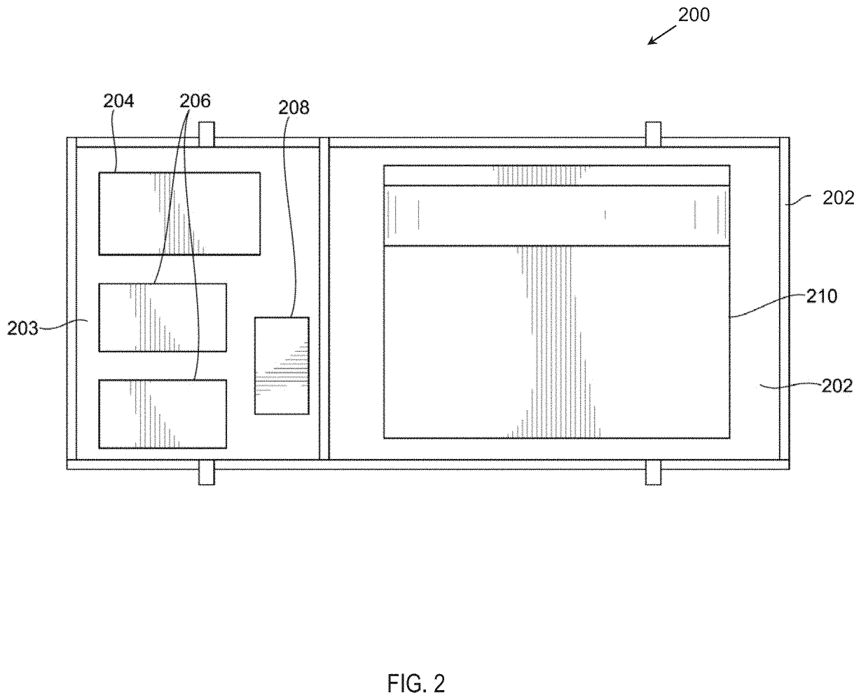

In some embodiments, the one or more PV cell elements 106 positioned on roof structure 104 is exposed to sunlight and subsequently converts captured solar energy into electrical energy, which can be used to directly charge the robotic mower. In some embodiments, the PV cell elements 106 may provide the generated electrical energy to a power supply unit (see, e.g., FIG. 2 description below). Power shed 100 can also use the generated electrical energy to provide power to accessories or charge the one or more local battery units (as shown in FIG. 2). In some embodiments, the battery unit(s) is a deep cycle battery unit(s).

In some embodiments, PV cell elements 106 may be a 72 cell, 60 Cell, or any other cell number depending on end use size and power needed for the charging of the automatic lawn mower, batteries, and other accessory equipment. For example, roof structure 104 may be a 72 cell panel, such as a 325 Watt polycrystalline 72 cell silver frame solar panel. Although the description herein discloses the use of a 72 cell panel, a panel with a greater or lesser number of cells and/or size can be utilized without departing from the scope of the disclosed subject matter. For example, it is possible to implement the power shed with a 60 cell panel in order to reduce the size of the power shed.

It is appreciated that the described solar roof component (e.g., roof structure 104 equipped with PV cell elements) allows for maximum site flexibility. Notably, the ability for the charging station to be powered without requiring a connection to a power grid or power lines allows an associated robotic mower to be situated in the most remote sites. As such, the power shed can be deployed any distance from any utility-connected power source.

In some embodiments, housing structure 102 may also be equipped with a plurality of leg structures or supports, such as legs 112. Notably, legs 112 can be used for staking and penetrating the ground surface. In some embodiments, the weight of the battery units can serve as ballasts for the power shed. Use of legs 112 or a similar anchoring system (and the overall weight of structure 102) can aid in resisting/overcoming any potentially high wind elements that may be experienced. This aspect further increases the difficulty of possible theft and/or vandalism of the power shed once deployed in the field of operation.

FIG. 2 is a block diagram illustrating a rear view of the interior of an exemplary solar powered robotic mower power shed according to an embodiment of the subject matter described herein. Notably, FIG. 2 depicts a housing structure 202 of a power shed 200 that includes a first compartment 202 (e.g., a robotic mower compartment) and a second compartment 203 (e.g., an electronical equipment compartment).

In some embodiments, first compartment 202 contains a charging station 210 that is configured to provide electrical power to a docked robotic mower (not shown). Charging station 210 can obtain electrical power from a power supply unit 208 (e.g., a charge control unit) and/or at least one battery unit 206 that are housed in a second compartment 203. For example, charging station 210 can utilize the battery storage afforded by battery unit(s) 206 to ensure the charging capacity for a robotic mower. Utilizing such a battery storage configuration allows for the charging station to support both day and night operations without requiring wired electrical power from a home, building, power utility, or the like. Battery unit(s) 206 may be connected to charging station 210, thereby affording maximum flexibility when a robotic mower is deployed for use. In some embodiments, battery unit(s) 206 can function as an additional power storage component to the robotic mower device's onboard battery.

It is understood that battery unit(s) 206 can comprise of any size, brand, or type without departing from the scope of the disclosed subject matter. In scenarios where charging station 210 may be unable to access sunlight, electrical power stored in battery unit(s) 206 can be utilized to sustain operation of the robotic mower or accessories supported by power shed 200, including wireless communication functionality, status lights, operational lighting, and the like. In addition, charging station 210 can provide power to a robotic motor using power supplied directly from power supply unit 208. In some embodiments, charging station 210 can charge a docked robotic mower by transferring the electrical power via contact pads/terminals, induction, or a wired connection. In some embodiments, for robotic mowers that require a current to the guide wire, power shed 200 and/or charging station 210 will be configured with connectors for the signal wire. For example, power for the robotic lawn mower guide wire(s) can be made available in direct current (DC) or alternating current (AC) for embodiments that require it. In some embodiments, a transformer element will be part of the component connection to drop the voltage. Second compartment 203 of power shed 200 may also include one or more electrical receptacles and/or outlets that allow a user to connect accessory devices (e.g., corded power tools) to the battery units and/or the power supply unit of the power shed.

In some embodiments, the power shed can be equipped with a plurality of lighting elements, such as light emitting diode (LED) devices. For example, the LED device may include one or more a programmable LED lighting strips. Notably, the LED devices (not shown) may be used to provide a status signal (e.g., a particular color, a particular intensity, and/or a particular flashing frequency) to an operator (or bystander) indicating that the robotic mower and/or the charging station is in a fault condition. In some embodiments, the status signal may also serve as an indication of the battery charge level of the battery unit(s) on the robotic mower and/or the power shed. The LED devices can also provide a visual signal that indicates that the robotic mower device is currently operating or whether the roof structure of the charging station is open. Further, a roof open indication signal can also be configured to illuminate the interior compartment of the power shed for the convenience and assistance to a user operator. In some embodiments, the power shed can also be configured with programmable color-changing lighting elements that can serve as safety lighting and/or decorative lighting (e.g., branding colors, campus colors, holiday theming, etc.) for additional aesthetic appeal. Notably, the power shed can produce, store and discharge energy required by the robotic mower. Such a flexible configuration enables the power shed to be sited in infrequently utilized or visited terrain. Further, the robotic mower can operate at a remote site so long as the solar PV modules (e.g., PV cell elements 106 shown in FIG. 1) associated with the charging station can collect sufficient solar power from sunlight.

In some embodiments, second compartment 203 can be configured to contain a DC/AC inverter 204 that is adapted to convert the DC solar energy into AC electrical energy that can be used to provide power to the robotic mower, power tool accessories, or other loads. Since the power shed allows for remote area deployments, the power shed can be configured with various elements for wireless communication including, but not limited to, a cellular data connection, a Wi-Fi repeater, or similar elements that enable an operator to communicate with charging station 210 and/or the robotic mower. For example, charging station 210 can be configured to be Wi-Fi extendable or cellular card (and/or chipset) enabled for purposes of monitoring and device tracking and/or communication. In addition, these wireless communications components can be used by charging station 210 to monitor and/or send control signals to the autonomous robotic mower device.

In some embodiments, charging station 210 has the ability to send and receive data from the robot mower unit using either the Wi-Fi extendable card or the cellular card (i.e., in such embodiments, the robotic mower is provisioned with an appropriate Wi-Fi and/or cellular card). Information collected by charging station 210 may be uploaded to a cloud based server were it can be viewed online by an end user (e.g., via an access point, such as a personal computer (PC), laptop, tablet device, and the like) or via a downloadable mobile device application (e.g., see smart phone application described below). Notably, this capability allows the user to view the operational status and performance metrics corresponding to the power shed and/or the supported robotic mower device. The wireless communications capability further enables a user to adjust a mower setting, such as, for example, directing the robotic mower to remain at the charging station based on a predefined battery charge level(s). Additional exemplary data that may be accessed, monitored, and/or managed by an operator via an online access point or a mobile device application includes, but is not limited to, the battery level of the power shed and/or the robotic mower device, the battery temperature of the power shed and/or the robotic mower device, the inverter status, the inverter temperature, power usage metrics from the robotic mower, power generation from solar energy captured by the power shed, the transformer temperature, and the like.

As indicated above, an operator or user can utilize a smart phone application and/or a web-based application to communicate and provide instructions to charging station 210. Notably, such an application (“app”) can be used to monitor, operate, and/or manage the system performance, control lighting, lock the power shed doors, rotate or adjust the roof structure, the charge control unit, and other functionalities performed locally at the power shed. Further, the smart phone app may be configured to utilize the wireless capabilities of its host mobile device (e.g., Wi-Fi, cellular, Bluetooth antenna(s) and circuitry) to establish and maintain a wireless connection with the power shed and/or robotic mower device.

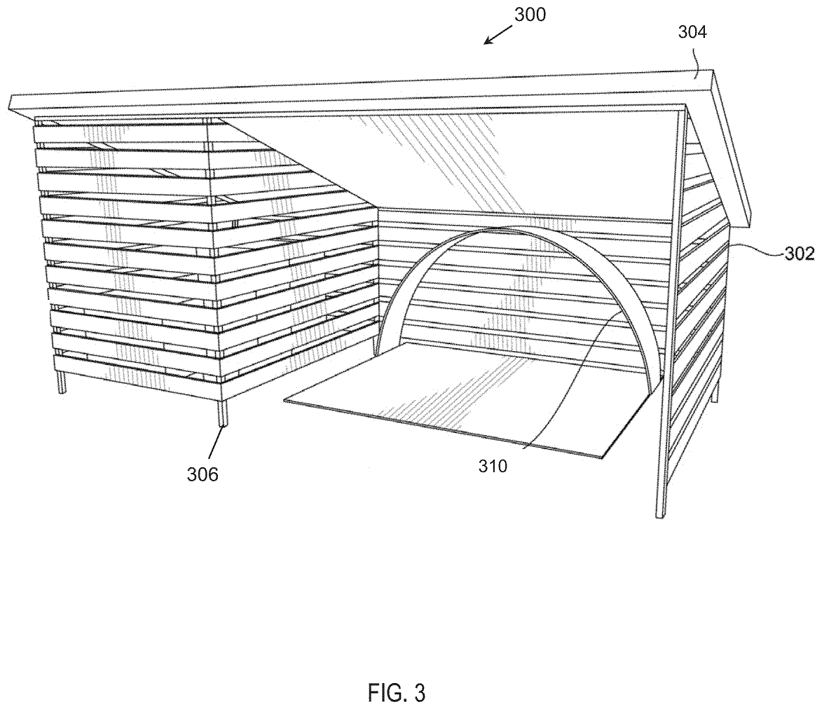

FIG. 3 is a diagram illustrating the front view of an exemplary solar powered robotic mower power shed according to an embodiment of the subject matter described herein. As shown in FIG. 3, a power shed 300 can be constructed using a steel frame and cladding slats 302. Although a steel frame and steel cladding are depicted, power shed 300 can be constructed using any suitable metallic material, plastic material, composite material, glass, or some combination thereof. In some embodiments, power shed 300 includes a plurality of compartments and/or sections. For example, the power shed may include a robotic mower docking compartment (e.g., first compartment 202 shown in FIG. 2) that houses a charging station 310 for the robotic mower device. Notably, the mower docking compartment allows the robotic mower device to enter the power shed 300 through an opening positioned in the front of the power shed (as shown in FIG. 3). In some embodiments, power shed 300 may be configured to have openings in both the front side and the rear side, thereby allowing a robotic mower device to enter from either side and subsequently pass through (e.g., without requiring the robotic mover device to reverse or back out of the charging station).

In some embodiments, the opening of the power shed can be covered with a charging station door (not shown) including, but not limited to, a manually operated door, an automated opening door, a screening element, or any other enclosing structure that is adapted to protect the robotic mower from debris, sight, weather, or the like. For example, the charging station door can be a side hinged door, a top flap opening hinged door, or a barn style door(s).

In some embodiments, power shed 300 can be securely set in place by pushing and/or inserting the support feet 306 into the soil. Alternatively, power shed 300 can be securely established using stakes or some other anchoring system (not shown). In some embodiments, power shed 300 can further be equipped to include one or more handles (not shown) that are welded in place for ease of transport, moving, and/or repositioning the power shed if needed.

In some embodiments, both the first compartment and the second compartment of power shed 300 can be accessed from above via the top roof portion. In some embodiments, a securable and/or hinged module top door (e.g., a roof/door with attached PV cell elements) can be utilized to access the interior electrical equipment. For example, where the roof structure of power shed 300 is a solar PV module, the solar PV module can be raised on one side and supported such that a user can access the first and second compartments for maintenance, cleaning, or inspection of electrical components and/or the robotic mower device. When the solar PV module is lowered, the roof structure can be secured to prevent unwanted access to the equipment contained in the first and second compartments of the power shed.

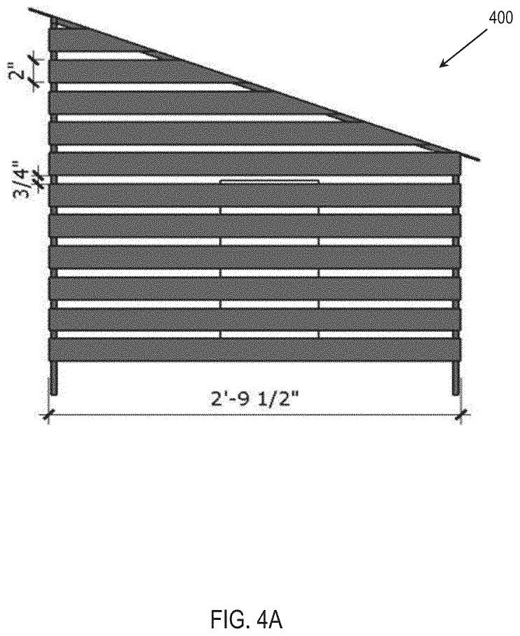

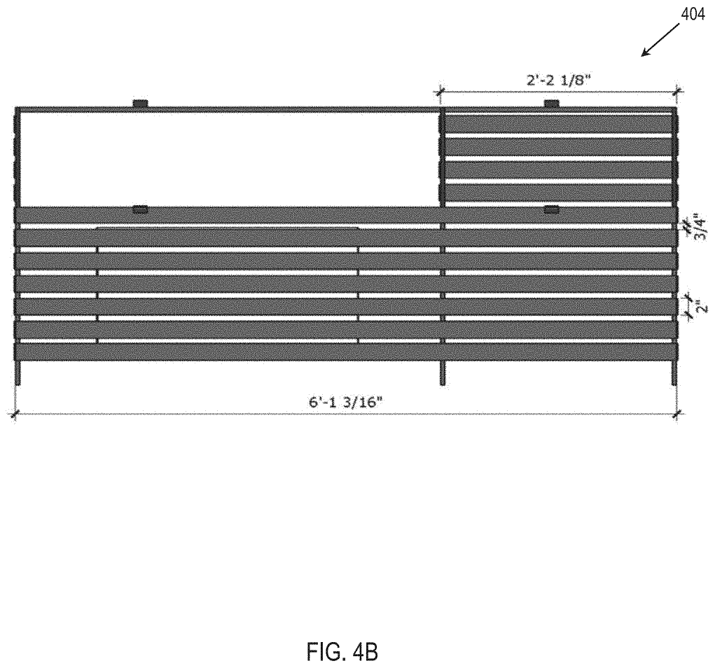

FIG. 4A depicts a side view 400 and FIG. 4B depicts a rear view 401 of the slats used in an exemplary solar powered robotic mower power shed according to an embodiment of the subject matter described herein. In particular, FIG. 4A depicts an exemplary construction of a power shed slats and cladding. For example, side view 400 illustrates that the width of an example power shed is 2 feet and 9.5 inches. Similarly, side view 400 (and rear view 404 in FIG. 4B) indicates that the slats are 2 inches wide with a ⅛th inch cross-section. The slats depicted in side view 400 (and rear view 404 in FIG. 4B) are spaced every ¾ inches. Likewise, rear view 404 illustrates that the total length of the example power shed is 6 feet, 1 and 3/16^{th} inches. View 404 further illustrates that the length of the example first compartment is 2 feet, 2 and ⅛^{th} inches. Although FIGS. 4A-B depict specific dimensions for an example power shed, the slats, and associated spacings, it is understood that other similar dimensions and/or lengths can be utilized without departing from the scope of the disclosed subject matter.

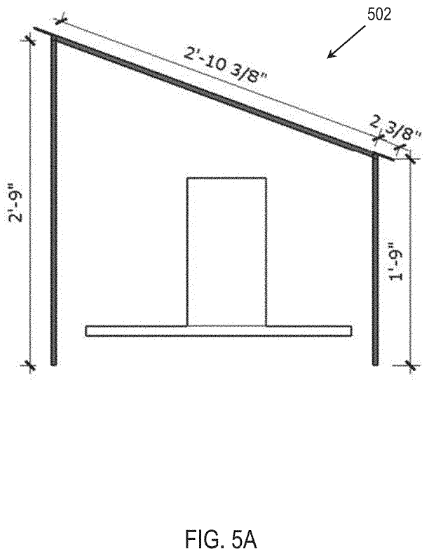

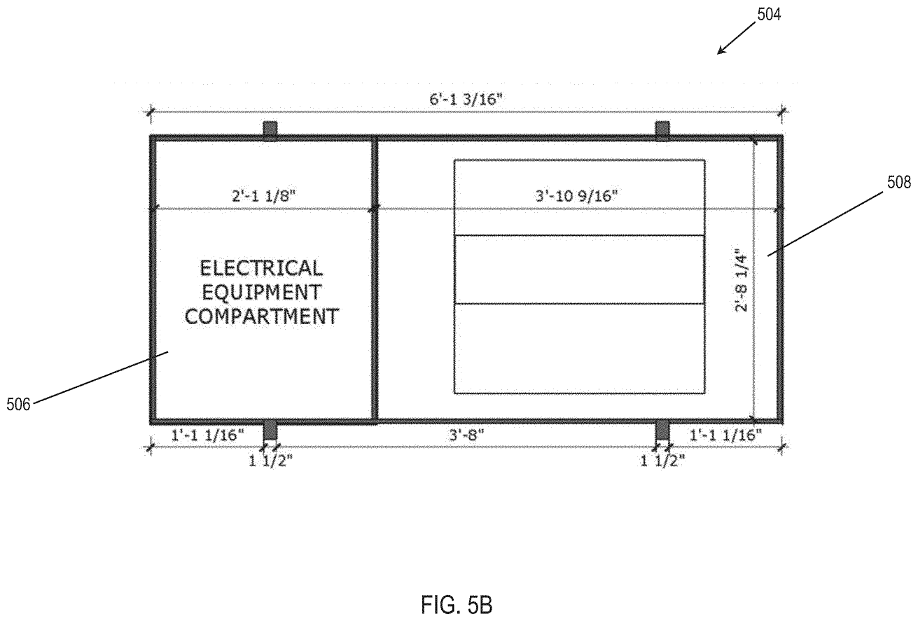

FIGS. 5A and 5B depict an interior side view and an interior rear view of a frame of an exemplary solar powered robotic mower power shed according to an embodiment of the subject matter described herein. Notably, FIG. 5A depicts a side view 502 of an exemplary frame of the power shed. As indicated in side view 502, the rear height of the example frame measures 2 feet and 9 inches and the front facing height measures 1 foot and 9 inches. A roof structure frame portion shown in side view 502 measures 2 feet and 10⅜^{th} inches. Likewise, rear view 504 in FIG. 5B indicates various dimensions for the electrical equipment compartment 506 and the mower compartment 508 of the power shed. In some embodiments, the roof structure is configured to be adjusted to an angle that permits the one or more PV cell elements to optimally receive solar light. Similarly, in some embodiments, the roof structure can also be configured to be rotated. Adjustment of the roof structure angle and rotating the roof structure can be conducted in either manually. In some embodiments, adjustment or rotation of the roof structure can be triggered by a wireless control signal sent to the power shed by an operator via a smart phone app or web-based application (e.g., a web site portal).

In some embodiments, the frame can be constructed in such a manner that the power shed can be modified to accommodate the flat and/or compact packaging of the charging station and containerize the electrical equipment. Similarly, some embodiments of the power shed frame are adapted to provide a reduced footprint or a customized configuration. Although FIGS. 5A and 5B depict specific dimensions for the frame of an example power shed, it is understood that any similar dimensions can be utilized without departing from the scope of the disclosed subject matter.

FIG. 6 depicts a diagram of a front perspective view 600 of an exemplary solar powered robotic mower power shed 602 according to an embodiment of the subject matter described herein. Notably, power shed 602 is configured to accommodate a charging station 604 (not unlike charging station 210 depicted in FIG. 2 and described above. FIG. 6 further depicts an example power mower device 606 that is docked in charging station 604. While docked in charging station 604 in this manner, power mower device 606 is configured to obtain electrical energy supplied from either one or more battery units or a power supply unit connected to charging station 604.

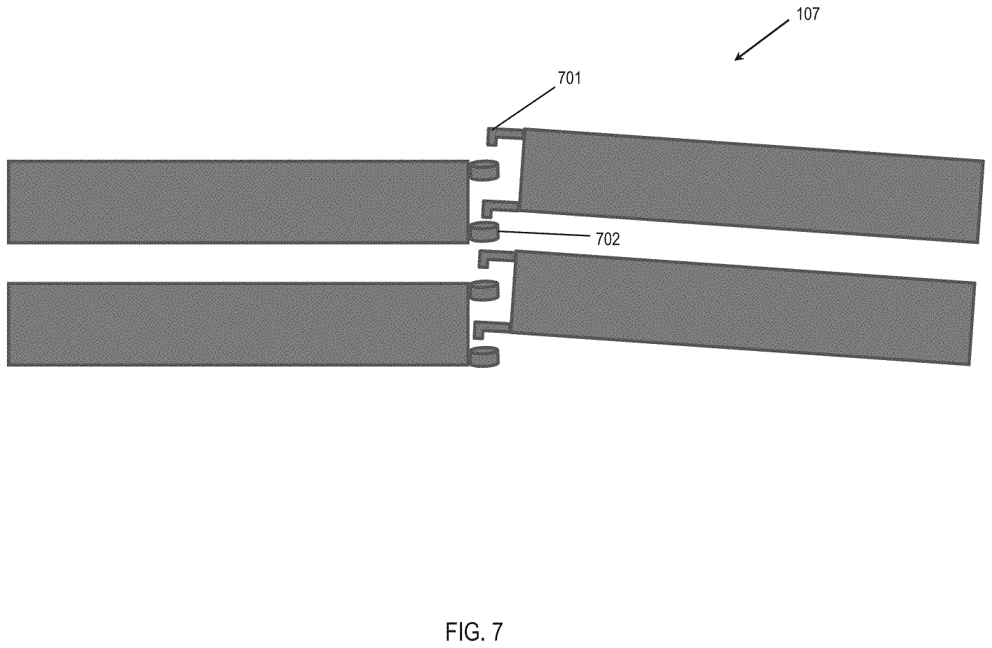

FIG. 7 depicts a diagram illustrating the interlocking features of an exemplary solar powered robotic mower power shed according to an embodiment of the subject matter described herein. In some embodiments, the slats and/or frame structure of the power shed housing structure can comprise a hook and latch interlocking system that can be adjusted for reducing the form factor of the housing structure of a power shed to a more compact form. As shown in FIG. 7, hook element 701 can be inserted and/or fitted into a loop element 702 to form the housing structure (e.g., the slats). Conversely, hook element 701 could be readily removed from loop element 702 to accommodate quick disassembly for prompt transport or shipment.

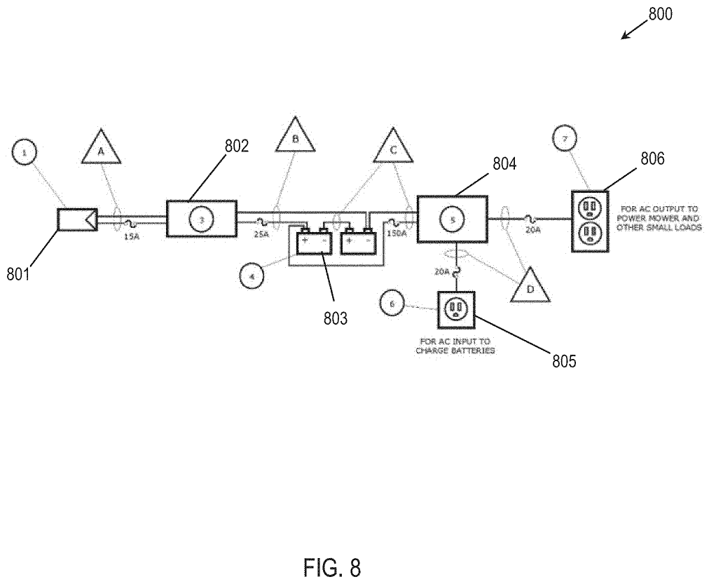

FIG. 8 is a schematic diagram illustrating an exemplary electrical circuit corresponding to a solar powered robotic mower power shed according to an embodiment of the subject matter described herein. In particular, FIG. 8 depicts a PV cell element(s) 801 that is connected to a charge control unit 802 (e.g., a power supply unit). Circuit 800 further illustrates charge control unit 802 separately connected to each of battery units 803 and a DC/AC inverter 804. Inverter 804 is coupled to AC output 806, which can be used to provide electrical power to a robotic mower and other loads. For example, AC output 806 Is configured to provide accessory, outdoor rated outlets for changing batteries for tools or any other electrical accessory component. Although not shown, circuit 800 may also include USB outlets in addition to the traditional receptacle outlet(s) shown.

Returning to FIG. 8, DC/AC inverter 804 can also be connected to an AC input 805 that can be used to receive electrical power for charging battery unit(s) 803. In some embodiments, circuit 800 may be configured with an outlet that bypasses inverter 804 in order to provide a direct DC charging option. Although circuit 800 depicts an example of the components utilized in the power shed, it is understood that other electrical components and elements can be used without departing from the scope of the disclosed subject matter.

All references listed herein, including but not limited to all patents, patent applications and publications thereof, and scientific journal articles, are incorporated herein by reference in their entireties to the extent that they supplement, explain, provide a background for, or teach methodology, techniques, and/or compositions employed herein.

While the following terms are believed to be well understood by one of ordinary skill in the art, the following definitions are set forth to facilitate explanation of the presently disclosed subject matter.

Unless defined otherwise, all technical and scientific terms used herein have the same meaning as commonly understood to one of ordinary skill in the art to which the presently disclosed subject matter belongs.

Following long-standing patent law convention, the terms “a,” “an,” and “the” refer to “one or more” when used in this application, including the claims.

The term “and/or” when used in describing two or more items or conditions, refers to situations where all named items or conditions are present or applicable, or to situations wherein only one (or less than all) of the items or conditions is present or applicable.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

The term “comprising,” which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

The embodiments disclosed herein are provided only by way of example and are not to be used in any way to limit the scope of the subject matter disclosed herein. As such, it will be understood that various details of the presently disclosed subject matter may be changed without departing from the scope of the presently disclosed subject matter. The foregoing description is for the purpose of illustration only, and not for the purpose of limitation.

What is claimed is:

1. A robotic mower power shed comprising:
a housing structure containing one or more compartments;
a roof structure equipped with one or more photovoltaic (PV) cell elements, wherein the one or more PV cell elements are configured to generate electrical energy from captured solar energy; and
a charge control unit configured to receive electrical energy via a connection to the one or more PV cell elements and to provide the electrical energy to at least a robotic mower device docked in the housing structure.

2. The robotic mower power shed of claim 1 further comprising a battery unit configured to receive and store additional electrical energy from the charge control unit.

3. The robotic mower power shed of claim 2 wherein the battery unit comprises a battery element of any size.

4. The robotic mower power shed of claim 1 comprising a plurality of lighting elements.

5. The robotic mower power shed of claim 4 wherein the plurality of light elements is configured to provide visual status signals.

6. The robotic mower power shed of claim 4 wherein each of the plurality of light elements is configured to emit a different color.

7. The robotic mower power shed of claim 1 wherein the one or more compartments in the housing structure comprise two or more compartments, and the two or more compartments are adjacently positioned either side-by-side or in a stacked arrangement.

8. The robotic mower power shed of claim 1 wherein the one or more PV cell elements forms a PV cell panel of any size.

9. The robotic mower power shed of claim 1 wherein the housing structure is equipped with a Wi-Fi repeater module.

10. The robotic mower power shed of claim 1 wherein the housing structure is equipped with a cellular communication module.

11. The robotic mower power shed of claim 1 further comprising a power outlet configured to charge additional power tool accessories.

12. The robotic mower power shed of claim 1 wherein the housing structure is manufactured from at least one of a metallic material, a plastic material, and/or a composite material.

13. The robotic mower power shed of claim 1 further comprising at least one carrying handle configured for transporting the robotic mower power shed.

14. The robotic mower power shed of claim 1 wherein the robotic mower power shed is configured to be folded and/or disassembled in a compact form for shipment or transport.

15. The robotic mower power shed of claim 1 wherein the housing structure includes at least one mower compartment door.

16. The robotic mower power shed of claim 15 wherein the at least one mower compartment door is configured to be opened either manually or automatically.

17. The robotic mower power shed of claim 1 wherein the housing structure is configured to include a plurality of entry points such that the robotic mower device is able to enter and/or exit from multiple sides of the housing structure.

18. The robotic mower power shed of claim 1 wherein the roof structure is configured to be adjusted to an angle that permits the one or more PV cell elements to optimally receive solar light.

19. The robotic mower power shed of claim 1 wherein the roof structure is configured to be rotated.

20. The robotic mower power shed of claim 1 wherein a smart phone application provisioned on a mobile device is configured to operate at least one of the roof structure, charge control unit, and the robotic mower device.
